(19) United States
(12) Patent Application Publication
(10) Pub. No.: US 2023/0360372 A1
(43) Pub. Date: Nov. 9, 2023

(54) ACCELERATED TRAINING OF NEURAL RADIANCE FIELDS-BASED MACHINE LEARNING MODELS

(71) Applicant: SHANGHAITECH UNIVERSITY, Shanghai (CN)

(72) Inventors: Fuqiang ZHAO, Shanghai (CN); Minye WU, Shanghai (CN); Lan XU, Shanghai (CN); Jingyi YU, Shanghai (CN)

(73) Assignee: SHANGHAITECH UNIVERSITY, Shanghai (CN)

(21) Appl. No.: 18/223,575

(22) Filed: Jul. 19, 2023

Related U.S. Application Data
(63) Continuation of application No. PCT/CN2021/073426, filed on Jan. 22, 2021.

(51) Int. Cl. G06V 10/774; G06V 10/82; G06T 7/50; G06T 7/80; G06V 10/74; G06V 20/64

(52) U.S. Cl. CPC G06V 10/774; G06V 10/82; G06T 7/50; G06T 7/80; G06V 10/761; G06V 20/64; G06T 2207/20081; G06T 2207/20084; G06T 2207/10028; G06V 40/172

(57) ABSTRACT

Systems, methods, and non-transitory computer-readable media are configured to obtain a set of content items to train a neural radiance field-based (NeRF-based) machine learning model for object recognition. Depth maps of objects depicted in the set of content items can be determined. A first set of training data comprising reconstructed content items depicting only the objects can be generated based on the depth maps. A second set of training data comprising one or more optimal training paths associated with the set of content items can be generated based on the depth maps. The one or more optimal training paths are generated based at least in part on a dissimilarity matrix associated with the set of content items. The NeRF-based machine learning model can be trained based on the first set of training data and the second set of training data.

### CROSS-REFERENCE TO THE RELATED APPLICATION

This application is a continuation (CON) of Internation Application No. PCT/CN2021/073426 filed on Jan. 22, 2021, the entire content of which is incorporated herein by reference.

### BACKGROUND

Machine learning techniques based on deep learning have led to numerous advancements in facial recognition, detection, and segmentation techniques. Recently, techniques of using neural radiance fields (NeRF) for surface reconstructions have gained traction in facial recognition. In NeRF, volume renderings of objects in three-dimension spaces are modeled and volume densities of the objects are used as weights to train a neural network for facial recognition. Compared to conventional techniques for facial recognition, a NeRF-based machine learning model (e.g., a neural network) can reconstruct surfaces that are smoother, more continuous, and have higher spatial resolutions. In some cases, the NeRF-based machine learning model can use less computing storage space than conventional techniques. Although the NeRF-based machine learning model offers numerous advantages over conventional techniques for facial recognition, training required for such a machine learning model can be laborious and time-consuming. For example, training a NeRF-based machine learning model for facial recognition can take multiple weeks.

### SUMMARY

Described herein, in various embodiments, are systems, methods, and non-transitory computer-readable media configured to obtain a set of content items to train a neural radiance field-based (NeRF-based) machine learning model for object recognition. Depth maps of objects depicted in the set of content items can be determined. A first set of training data comprising reconstructed content items depicting only the objects can be generated based on the depth maps. A second set of training data comprising one or more optimal training paths associated with the set of content items can be generated based on the depth maps. The one or more optimal training paths are generated based at least in part on a dissimilarity matrix associated with the set of content items The NeRF-based machine learning model can be trained based on the first set of training data and the second set of training data.

In some embodiments, the depth maps of the objects depicted in the set of content items can be determined by calculating internal and external parameters of cameras from which the set of content items was captured. Coarse point clouds associated with the objects depicted in the set of content items can be determined based on the internal and external parameters. Meshes of the objects depicted in the set of content items can be determined based on the coarse point clouds. The depth maps of the objects depicted in the content items can be determined based on the meshes of the objects.

In some embodiments, the internal and external parameters of the cameras can be determined using a Structure from Motion (SfM) technique and the meshes of the objects can be determined using a Poisson reconstruction technique.

In some embodiments, the internal and external parameters of the cameras and the meshes of the objects can be determined using a multiview depth fusion technique.

In some embodiments, the first set of training data can be determined by determining pixels in each content item of the set of content items to be filtered out based on the depth maps. The pixels in each content item of the set of content items can be filtered out. Remaining pixels in each content item of the set of content items can be sampled to generate the reconstructed content items.

In some embodiments, the pixels in each content item of the set of content items to be filtered out can be determined by determining pixels in each content item of the set of content items that are outside a threshold depth range indicated by a corresponding depth map of each content item. The threshold depth range can indicate a depth range of an object depicted in each content item.

In some embodiments, the second set of training data can be generated by determining depth map matching metrics of the set of content items. Silhouette matching metrics of the set of content items can also be determined. A dissimilarity matrix associated with the set of content items can be generated based on the depth map matching metrics and the silhouette matching metrics. A connected graph associated with the set of content items can be generated based on the dissimilarity matrix. The one or more optimal training paths associated with the set of content items can be generated by applying a minimum spanning tree technique to the connected graph. The minimum spanning tree technique can rearrange the connected graph into multiple subtrees and each path of the multiple subtrees is an optimal training path.

In some embodiments, the depth map matching metrics of the set of content items can be determined based on comparing depth maps of two content items of the set of content items. The two content items can depict an object. A dissimilarity value of each depth point in the depth maps of the two content items can be computed. Dissimilarity values of depth points in the depth maps of the two content items can be summed to generate a depth map matching metric for the two content items.

In some embodiments, the silhouette matching metrics of the objects can be determined based on comparing depth maps of two content items of the set of content items. The two content items can depict an object. Contour information associated with the object contained in the depth maps of the two content items can be compared. A silhouette matching metric for the two content items can be computed based on the comparison of the contour information.

In some embodiments, columns and rows of the dissimilarity matrix can correspond to frame numbers associated with the set of the content items. Values of the dissimilarity matrix can indicate a degree of dissimilarity between any two content items of the set of content items as indicated by their respective frame numbers. The values of the dissimilarity matrix can be determined based on respective depth map matching metric and the silhouette matching metric of any two content items of the set of content items.

These and other features of the apparatuses, systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an example system including an object recognition module configured to identify objects, in accordance with various embodiments of the present disclosure.

FIG. 2 illustrates an example training data preparation module, in accordance with various embodiments of the present disclosure.

FIG. 3A illustrates an example reconstructed content item depicting an object and an example depth range, in accordance with various embodiments of the present disclosure.

FIG. 3B illustrates a method for generating a reconstructed content item depicting only an object of interest with which to train a NeRF-based machine learning model for object recognition, in accordance with various embodiments of the present disclosure.

FIG. 3C illustrates a diagram for generating one or more optimal training paths with which to train a NeRF-based machine learning model for object recognition, in accordance with various embodiments of the present disclosure.

FIG. 4 illustrates a method for training a NeRF-based machine learning model for object recognition, in accordance with various embodiments of the present disclosure.

FIG. 5 is a block diagram that illustrates a computer system upon which any of various embodiments described herein may be implemented.

### DETAILED DESCRIPTION OF THE EMBODIMENTS

Machine learning techniques based on deep learning have led to numerous advancements in facial recognition, detection, and segmentation techniques. Recently, techniques of using neural radiance fields (NeRF) for surface reconstructions have gained traction in facial recognition. In NeRF, volume renderings of objects in three-dimension spaces are modeled and volume densities of the objects are used as weights to train a neural network for facial recognition. Compared to conventional techniques for facial recognition, a NeRF-based machine learning model (e.g., a neural network) can reconstruct surfaces that are smoother, more continuous, and have higher spatial resolutions. In some cases, the NeRF-based machine learning model can use less computing storage space than conventional techniques. Although the NeRF-based machine learning model offers numerous advantages over conventional techniques for facial recognition, training required for such a machine learning model can be laborious and time-consuming. For example, training a NeRF-based machine learning model for facial recognition can take multiple weeks. As such, a NeRF-based machine learning model may not be suitable for commercial applications.

Described herein is a solution that addresses the problems described above. In various embodiments, a machine learning model, such as a multilayer perceptron (MLP) neural network, can be trained to recognize features of objects (or facial features) based on NeRF associated with the objects (or faces of persons). As discussed above, object recognition (or facial recognition) based on a trained NeRF-based machine learning model can offer many advantages over conventional object recognition techniques. However, time needed to train such a machine learning model can be time-consuming. Therefore, to reduce the time needed to train the NeRF-based machine learning model, training data with which to train the NeRF-based machine learning model can be preprocessed. Preprocessing of the training data can reduce the time needed to train the NeRF-based machine learning model. As used here, object recognition and facial recognition are interchangeable. Techniques described herein can be applied to object recognition and/or facial recognition applications.

In various embodiments, training data with which to train the NeRF-based machine learning model for object recognition can comprise a set of content items (e.g., images, videos, looping videos, etc.). The set of content items can depict various objects and/or features of the objects. In some embodiments, the set of content items can be preprocessed to determine depth maps of the objects depicted in the set of content items. For example, an image depicts a person in a scene. In this example, a distance to the person from a camera from which the image was taken can be estimated. In this example, distances to various points (e.g., head, body, etc.) of the person can be estimated and used to generate a depth map of the person. In general, a depth map contains information relating to depths (e.g., distances) of surfaces of an object depicted in a content item from viewpoints associated with the content item. The depth maps of the objects can be determined based on meshes of the objects (e.g., geometric or polygonal representation of objects). The meshes of the objects can be determined based on coarse point clouds of the objects depicted in the set of content items. The coarse point clouds of the objects can be calculated based on internal and external parameters of cameras from which the set of content items was captured. Once the depth maps of the objects are determined, two sets of training data with which to train the NeRF-based machine learning model for object recognition can be generated.

In some embodiments, a first set of the two sets of training data can comprise reconstructed content items. The reconstructed content items can be generated from the set of content items based on the depth maps of the objects. For example, an image depicting a person can be superimposed with a depth map of the person. In this example, by superimposing the image with the depth map, depths (e.g., distances) of the person from a viewpoint of the image can be determined. Once the depths of the person are determined, only pixels of the image corresponding to the person are sampled to construct a reconstructed image depicting only the person. In this example, other pixels of the image are abandoned or not sampled. In this way, a size (e.g., a file size) of the training data can be greatly reduced. In addition, time needed to train the NeRF-based machine learning model can be reduced because reconstructed content items, instead of regular content items, are used for training. For example, an image can depict a person in foreground and a tree in background. In this example, an object of interest is the person. By sampling pixels corresponding only to the person in a reconstructed image, only the person is considered for a NeRF-based machine learning model for object recognition, the tree is not considered for training. As such, training of the NeRF-based machine learning model can be targeted to only objects that the NeRF-based machine learning model is trained to recognize—in this case, persons.

In some embodiments, a second set of the two sets of training data can comprise one or more optimal training paths for the NeRF-based machine learning model. The one or more optimal training paths can allow the NeRF-based machine learning model to be trained in parallel, thereby accelerating training of the NeRF-based machine learning model. In some embodiments, each of the one or more optimal training paths can include one or more content items depicting a same object in a sequence (e.g., a time sequence, a motion sequence, etc.) or from different viewpoints. In some embodiments, the one or more optimal training paths can be generated based on a fully connected graph corresponding to the set of content items of the training data. The fully connected graph can be constructed based on a dissimilarity matrix associated with the set of content items. In general, a dissimilarity matrix, as used here, indicates a degree of dissimilarity between any two content items (e.g., images or image frames) of the set of content items depicting a same or similar object. The dissimilarity matrix can speed-up multi-frame training of the NeRF-based machine learning model by identifying and grouping content items that depict same or similar objects in a sequence or from different viewpoints. In some embodiments, values of the dissimilarity matrix can be determined based on depth map matching metrics and silhouette matching metrics of the set of content items. The depth map matching metrics can be determined by comparing depth maps of any two content items depicting a same or similar object in a sequence or from different viewpoints. The silhouette matching metrics can be determined by comparing contours of a same or similar object contained in depth maps of any two content items depicting the object in a sequence or from different viewpoints. Once the fully connected graph is constructed, the one or more optimal training paths can be generated by evaluating the fully connected graph through a minimum spanning tree technique with the values of the dissimilarity matrix being edge weights of the minimum spanning tree technique. The minimum spanning tree technique can arrange the set of content items in such a way that minimizes dissimilarities between the objects depicted in the set of content items in a training path. In this way, training of the NeRF-based machine learning model can be optimized, thereby reducing time needed for training. These and other features of the solution are discussed in further detail below.

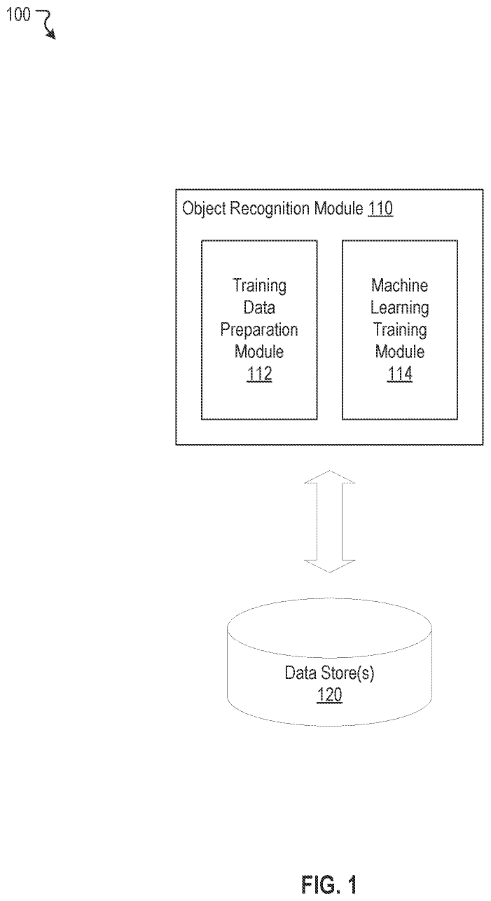

FIG. 1 illustrates an example system 100 including an object recognition module 110 configured to identify objects, in accordance with various embodiments of the present disclosure. In various embodiments, the object recognition module 110 can be implemented as a NeRF-based machine learning model trained to identify objects depicted in content items (e.g., images, videos, looping videos, etc.) based on volume rendering of the objects. The objects depicted in the content items can include, for example, faces of persons, facial features, animals, types of vehicles, license plate numbers of vehicles, etc. The NeRF-based machine learning model can be implemented using any suitable machine learning techniques. For example, the NeRF-based machine learning model can be implemented using a multilayer perceptron (MLP) neural network. In some cases, the NeRF-based machine learning model can be implemented using one or more classifiers based on logistic regression. Many variations are possible. In some embodiments, the object recognition module 110 can be implemented, in part or in whole, as software, hardware, or any combination thereof. In some embodiments, the object recognition module 110 can be implemented, in part or in whole, as software running on one or more computing devices or systems, such as a cloud computing system. For example, a trained NeRF-based machine learning model can be implemented, in part or in whole, on a cloud computing system to identify objects or features of the objects depicted in captured images or video feeds. Many variations are possible.

In some embodiments, as shown in FIG. 1, the system 100 can further include at least one data store 120. The object recognition module 110 can be configured to communicate and/or operate with the at least one data store 120. The at least one data store 120 can store various types of data associated with the object recognition module 110. For example, the at least one data store 120 can store training data with which to train a NeRF-based machine learning model for object recognition. The training data can include, for example, images, videos, and/or looping videos depicting various objects. For instance, the at least one data store 120 can store a plurality of images depicting cats to train a NeRF-based machine learning model to recognize cats. In some embodiments, the at least one data store 120 can store various internal and external parameters of cameras, coarse point clouds, depth maps, etc. accessible to the object recognition module 110. In some embodiments, the at least one data store 120 can store various metrics and dissimilarity matrices accessible to the object recognition module 110. In some embodiments, the at least one data store 120 can store machine-readable instructions (e.g., codes) that, when executed, cause one or more computing systems to perform training of a NeRF-based machine learning model for object recognition or identify objects the NeRF-based machine learning model is trained to recognize. In some embodiments, the at least one data store 120 can include a database that stores information relating to faces of persons. For example, the at least one data store 120 can include a database storing facial features of persons. This database can be used to identify persons recognized by a trained NeRF-based machine learning model. For instance, faces recognized by the trained NeRF-based machine learning model can be compared with a database storing facial features of criminals or persons suspected of committing crimes.

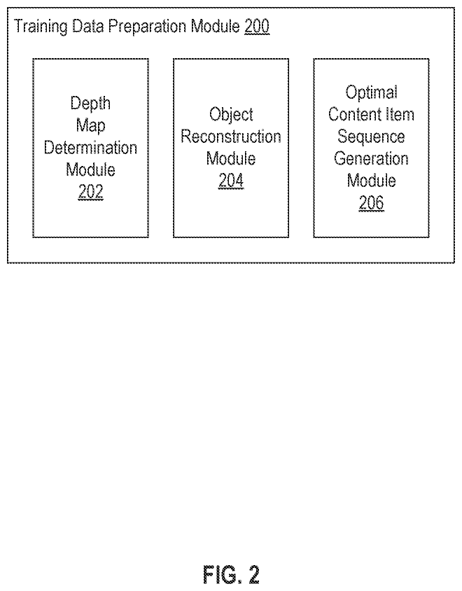

In some embodiments, the object recognition module 110 can include a training data preparation module 112 and a machine learning training module 114. The training data preparation module 112 can be configured to preprocess training data with which train a NeRF-based machine learning model for object recognition. Preprocessing training data can shorten or reduce time needed to train the NeRF-based machine learning model. In some embodiments, the training data preparation module 112 can obtain a set of content items to train the NeRF-based machine learning model. The set of content items can include, for example, images, videos, looping videos depicting various objects. For example, training data comprising a set of images depicting various facial features can be used to train a NeRF-based neural network to recognize faces and to compare the recognized faces with information stored in the at least one data store 120. In some embodiments, the training data preparation module 112 can determine depth maps of the objects depicted in the set of content items. In general, a depth map contains information relating to depths (e.g., distances) of surfaces of an object depicted in a content item from viewpoints associated with the content item. Based on the depth maps of the objects, the training data preparation module 112 can generate a first set of training data comprising reconstructed content items depicting only the objects and a second set of training data comprising one or more optimal training paths with which to train the NeRF-based machine learning model. The training data preparation module 112 will be discussed in further detail with reference to FIG. 2 herein.

In some embodiments, the machine learning training module 114 can be configured to train a NeRF-based machine learning model for object recognition. The machine learning training module 114 can train the NeRF-based machine learning model based on the first set and the second set of training data generated by the training data preparation module 112. Based on the reconstructed content items in the first set of training data and the one or more optimal training paths in the second set of training data, the machine learning training module 114 can parallelly train the NeRF-based machine learning model for object recognition. For example, a NeRF-based MLP neural network can be trained to identify faces of persons by simultaneously training the NeRF-based MLP neural network using reconstructed images depicting only facial features of faces as input training data and one or more optimal image training paths as weights of the NeRF-based MLP neural network. In this way, time needed to train the NeRF-based MLP neural network can be shortened or reduced. As discussed above, conventional methods of training a NeRF-based machine learning model can be very time-consuming. By preprocessing training data with which to train the NeRF-based machine learning model, time needed for training can be reduced by orders of magnitude.

FIG. 2 illustrates an example training data preparation module 200, in accordance with various embodiments of the present disclosure. In some embodiments, the training data preparation module 112 of FIG. 1 can be implemented as the training data preparation module 200. As shown in FIG. 2, in some embodiments, the training data preparation module 200 can include a depth map determination module 202, an object reconstruction module 204, and an optimal content item sequence generation module 206. Each of these modules will be discussed in detail below.

In some embodiments, the depth map determination module 202 can be configured to determine depth maps of objects depicted in content items of training data. As discussed, in general, a depth map can contain information relating to depths (e.g., distances) of surfaces of an object depicted in a content item from viewpoints associated with the content item. For example, an image depicts a person in a scene. In this example, the depth map determination module 202 can determine a depth (e.g., a distance) of the person relative to a viewpoint of the scene at every depth point (e.g., head, body, etc.) associated with the person. In some embodiments, the depth map determination module 202 can determine the depth maps of the objects depicted in the content items by first calculating internal and external parameters of cameras from which the content items were captured. The internal parameters (or intrinsic parameters) of the cameras can include, for example, focal lengths and lens distortions of the cameras. The external parameters (or extrinsic parameters) of the cameras can include, for example, parameters that describe transformations between the cameras and their external environments. For instance, the external parameters can include rotational matrices with which to rotate or translate the objects depicted in the content items. In some embodiments, the depth map determination module 202 can determine the internal and external parameters of the cameras by using a Structure from Motion (SfM) technique. A SfM technique is a photogrammetric ranging technique for determining spatial and geometric relationships of objects depicted in content items through movements of cameras. In some cases, the depth map determination module 202 can determine the internal and external parameters of the cameras by using a multiview depth fusion technique. Many variations are possible.

In some embodiments, the depth map determination module 202 can generate coarse point clouds of the objects depicted in the content items based on the internal and external parameters of the cameras. The coarse point clouds of the objects can represent shapes and/or contours of the objects as three-dimensional surfaces in a three-dimensional space. For example, an image depicting a face of a person can be used to estimate internal or external parameters of a camera from which the image was captured. In this example, the depth map determination module 202 can generate a coarse point cloud of the face based on the internal or external parameters. In this coarse point cloud, facial features of the face are represented as three-dimensional surfaces with various local peaks and troughs highlighting contours (e.g., facial features) of the face.

In some embodiments, the depth map determination module 202 can generate meshes of the objects depicted in the content items based on the coarse point clouds. In general, meshes are polygonal shapes (e.g., triangles, squares, rectangles, etc.) in a three-dimensional space that represent shapes and/or contours of objects represented in the coarse point clouds. For example, the depth map determination module 202 can generate a mesh of a face based on a coarse point cloud of the face. In this example, various contours of the face are represented by a plurality of polygonal shapes, such as triangles, highlighting various facial features of the face. In this way, contours of a surface can be easily visualized while reducing computing loads needed to render such a surface. From the meshes, the depth map determination module 202 can determine the depth maps of the objects depicted in the content items. Depths of the objects in the depth maps can be estimated based on pixel ray tracing to every mesh point (e.g., points of polygonal shapes) of the objects. In some embodiments, the depth map determination module 202 can generate the meshes of the objects based on a Poisson reconstruction technique.

In some embodiments, the object reconstruction module 204 can be configured to sample pixels in the content items of the training data that are necessary to construct objects depicted in the content items in reconstructed content items. The sampled pixels can be used to generate the reconstructed content items, which can then be used to train a NeRF-based machine learning model for object recognition. For example, a first image can depict a person in foreground and a tree in background. In this example, the object reconstruction module 204 can be configured to sample pixels in the first image that correspond to only the person. The sampled pixels are used to construct the person in a second image with which to train a NeRF-based machine learning model for person recognition. As discussed, in this way, time needed to train the NeRF-based machine learning model can be reduced. Furthermore, file sizes of content items (i.e., reconstructed content items depicting only objects of interest) with which to train the NeRF-based machine learning model can be reduced as well.

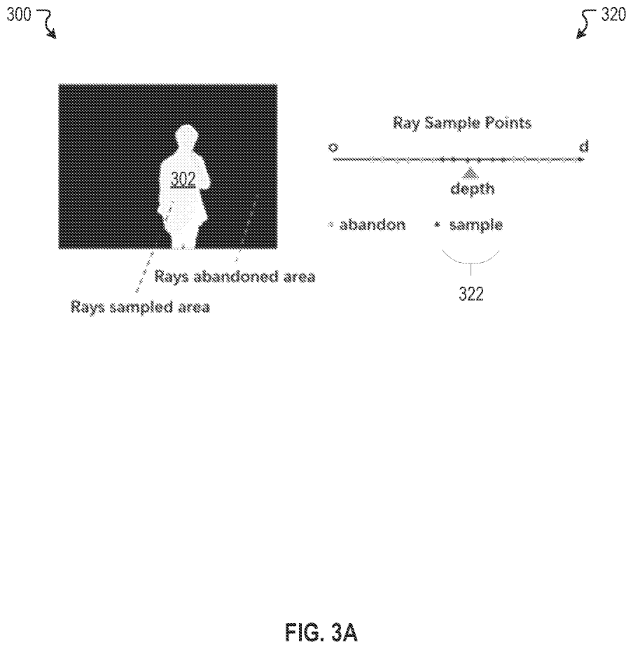

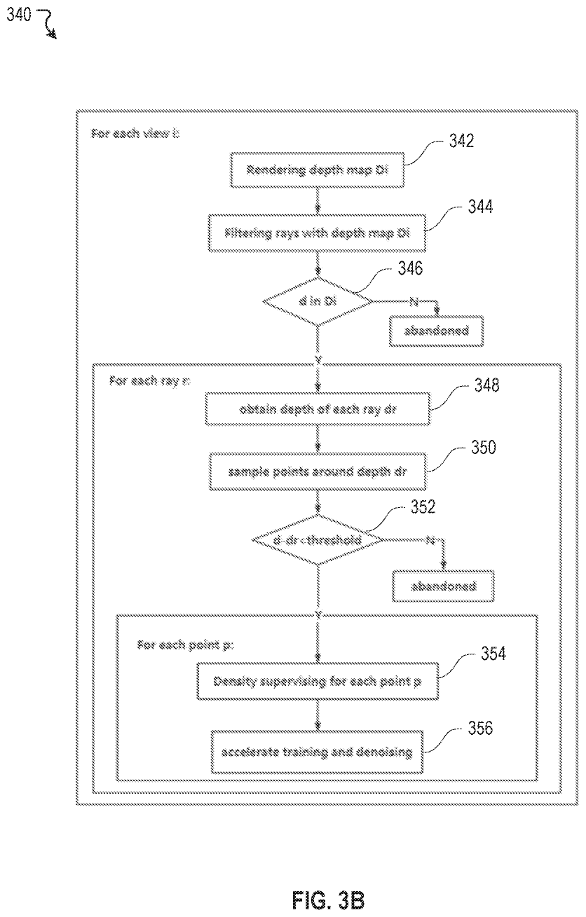

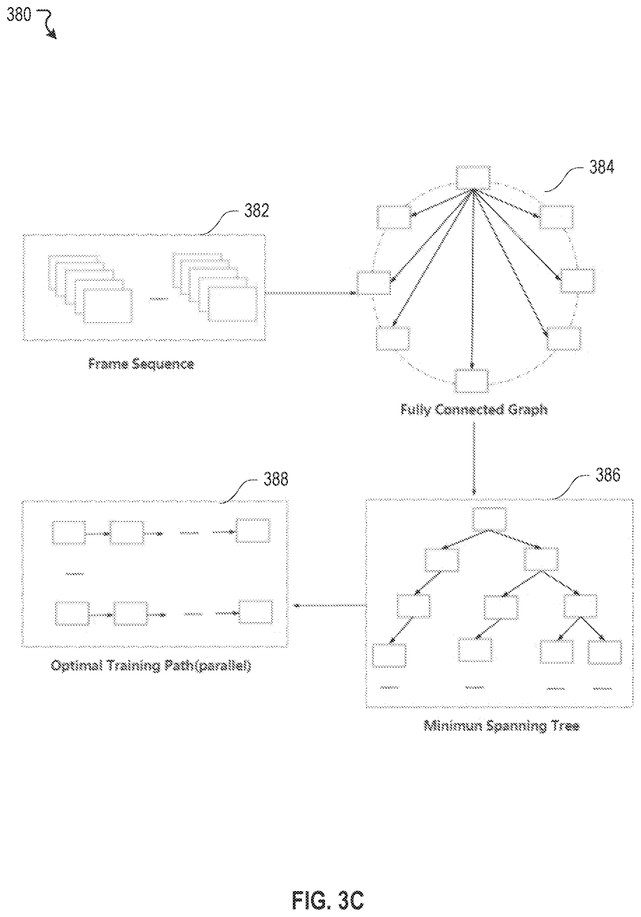

In some embodiments, the object reconstruction module 204 can identify pixels in a content item necessary to construct an object depicted in the content item based on a depth map of the object. The depth map of the object can include information relating to depths (e.g., distances) of various surfaces of the object relative to viewpoints associated with the content item. These depths can form a basis for a threshold depth range with which to filter pixels that correspond to the object. For example, pixels corresponding to depths that fall outside of the threshold depth range are abandoned (e.g., filtered out or not sampled) because these pixels do not represent the object. While pixels corresponding to depths that fall within the threshold depth range are sampled for construction of the object in a reconstructed content item. As such, the object reconstruction module 204 can sample pixels that correspond to objects depicted in content items based on whether pixels of the content items fall within threshold depth ranges of the objects in accordance with their depth maps. Based on the sampled pixels, the object reconstruction module 204 can construct the objects in a set of reconstructed content items to train a NeRF-based machine learning model for object recognition. This set of reconstructed content items can be used as inputs (e.g., training data) to train the NeRF-based machine learning model. The object reconstruction module 204 will be discussed in further detail with reference to FIGS. 3A and 3B herein.

In some embodiments, the object reconstruction module 204 can sample pixels that correspond to an object depicted in a content item uniformly in N evenly-spaced bins and sample pixels within the N evenly-spaced bin for construction of the object in a reconstructed content item. This approach can further reduce file sizes of content items with which to train the NeRF-based machine learning model. However, this approach may cause low sampling space utilization which may negatively impact quality of reconstructed content items. Therefore, to minimize low sampling space utilization, sampling of pixels from the N evenly-spaced bin can be dynamically adjusted. For example, a face depicted in a reconstructed image may be sampled from pixel data stored in N evenly-spaced bins. In this example, the face may not have enough resolution to represent various contours of the face. As such, sampling from the N-evenly-space bins can be adjusted such that more pixel data corresponding to the face are sampled for construction of the reconstructed image.

In some embodiments, the object reconstruction module 204 can be configured to remove noise associated with reconstructed content items. In general, filtering out pixels not corresponding to objects depicted in content items can lead to noise in reconstructed content items depicting only the objects. This noise is especially prevalent around edges or silhouette of the objects depicted in the reconstructed content items. Thus, in some embodiments, the object reconstruction module 204 can be configured to removed or minimized the noise through a density supervision technique as instructed or directed by a user. In the density supervision technique, human supervisions are needed to monitor meshes associated with the reconstructed content items to remove noise caused by unsampled pixels (i.e., filtered out pixels). In some cases, the density supervision technique can lead to accelerated training of a NeRF-based machine learning model for object recognition.

In some embodiments, the optimal content item sequence generation module 206 can be configured to generate one or more optimal training paths for the content items of the training data. The one or more optimal training paths can accelerate training of a NeRF-based machine learning model for object recognition. Each of the one or more optimal training paths can include one or more content items depicting a same or similar object in a sequence (e.g., a time sequence, a motion sequence, etc.) or different viewpoints. For example, training data with which to train a NeRF-based machine learning model for object recognition can comprise a plurality of images depicting various objects. The plurality of images can be organized such that one or more images of the plurality of images depicting a same object can be arranged into a sequence. In some embodiments, the optimal content item sequence generation module 206 can generate the one or more optimal training paths based on a fully connected graph associated with the content items of the training data. Each node of the fully connected graph can correspond to a content item of the training data. In some embodiments, the fully connected graph can be constructed based on a dissimilarity matrix associated with the content items of the training data. Columns and rows of the dissimilarity matrix can represent frame numbers of the content items, while values of the dissimilarity matrix, or dissimilarity metrics, can be used as edge weights to evaluate the fully connected graph through a minimum spanning tree technique. Under the minimum spanning tree technique, the fully connected graph can be rearranged into multiple subtrees based on the values of the dissimilarity matrix. Each path of the multiple subtrees can represent one or more content items of an optimal training path.

In some embodiments, a value (e.g., a dissimilarity metric) of a dissimilarity matrix can be determined as follows:

F_{i,j}=D_{i,j}·(1−S_{i,j})

where F_{i,j} is a value (e.g., a dissimilarity metric) of the dissimilarity matrix at row i (e.g., frame i of the content items of the training data) and column j (e.g., frame j of the content items of the training data) of the dissimilarity matrix, D_{i,j} is a depth map matching metric between frame i and frame j, and S_{i,j} is a silhouette matching metric between frame i and frame j. The depth map matching metric compares differences in depth maps of two content items (e.g., frame i and frame j). In some embodiments, a depth map matching metric between any two content items of the training data can be determined as follows:

$${D}_{i , j} = {\sum }_{c = 1}^{M} \vert {d}_{{F}_{i}} - {d}_{{F}_{j}} \vert$$

where d_{Fi} is a depth map of frame Fᵢ at viewpoint c, d_{Fj} is a depth map of frame Fⱼ at viewpoint c, and M is a total number of viewpoints in depth maps of frame Fᵢ and frame Fⱼ. As such, the depth map matching metric is a summation of all of depth differences in depth maps of any two content items (e.g., frame i and frame j) depicting an object. The silhouette matching metric compares silhouette or contour information of an object depicted in two content items (e.g., frame i and frame j) based on depth maps of the two content items. In some embodiments, a silhouette matching metric between any two content items of the training data can be determined as follows:

$${s}_{i , j} = \frac{1}{M} {\sum }_{c = 1}^{M} \frac{{I}_{i , j}^{c}}{{U}_{i , j}^{c}}$$

where I^{c}_{i,j} is a silhouette intersection of frame i and frame j at viewpoint c, U^{c}_{i,j} is silhouette union of frame i and frame j at viewpoint c, and M is a total number of viewpoints in depth maps of frame Fᵢ and frame Fⱼ. The optimal content item sequence generation module 206 will be discussed in further detail with reference to FIG. 3C herein.

FIG. 3A illustrates an example reconstructed content item 300 depicting an object and an example depth range 320, in accordance with various embodiments of the present disclosure. As shown in FIG. 3A, the reconstructed content item 300 (e.g., an image) depicts only an object 302 and nothing else (e.g., darkened portions of the reconstructed content item 300). In various embodiments, the reconstructed content item 300 can be generated based on sampling of pixels (e.g., “Rays”) of an original content item depicting the object 302. Only pixels corresponding to the object 302 in the original content item are sampled (e.g., “Rays sampled area”), while pixels not corresponding to the object 302 in the original content item are not sampled (e.g., “Rays abandoned area”).

In some embodiments, each pixel of the original content item can be associated with a depth range (e.g., the depth range 320). The depth range of each pixel can be determined based on a depth map of the original content item and includes a threshold depth range (e.g., a threshold depth range 322) that indicates depths of the object 302 depicted in the original content item as represented by each pixel. The depth range of each pixel can be compared to the threshold depth range. If a depth range of a pixel is outside of the threshold depth range, the pixel does not represent the object 302 and thus is not sampled for the reconstructed content item 300. Whereas, if a depth range of a pixel is within the threshold depth range, the pixel does represent the object 302 and thus is sampled for the reconstructed content item 300. For example, as shown in FIG. 3A, the depth range 320 has a depth of “d.” This depth falls outside of the threshold depth range 322. Therefore, the pixel corresponding to the depth range 320 is not sampled for the reconstructed content item 300.

FIG. 3B illustrates a method 340 for generating a reconstructed content item depicting only an object of interest with which to train a NeRF-based machine learning model for object recognition, in accordance with various embodiments of the present disclosure. As shown in FIG. 3B, a processor of a computing system, at block 342, can render a depth map of an object depicted in a content item. The processor, at block 344, can filter out pixels (e.g., “rays”) from the content item based on the depth map. At block 346, if pixels (e.g., “d”) of the content item do not correspond to the depth map (e.g., “Di”), the pixels are abandoned. If the pixels of the content item correspond to the depth map, the pixels are evaluated for their respective depths based on the depth map. At block 348, the processor obtains depths of the pixels from the depth map. At blocks 350 and 352, the processor determines whether to sample the pixels for construction of the object in the reconstructed content item based on whether the depths are within a threshold depth range. If the depths of the pixels are less than the threshold depth range, the pixels are abandoned. If the depths of the pixels equal or exceed the threshold depth range, the pixels are sampled for construction of the object in the reconstructed content item. At block 354, the processor, with input from a user, can perform density supervision to minimize noise associated with pixels that represent silhouette of the object in the reconstructed content item. At block 356, the processor can train the NeRF-based machine learning model using the reconstructed content item.

FIG. 3C illustrates a diagram 380 for generating one or more optimal training paths with which to train a NeRF-based machine learning model for object recognition, in accordance with various embodiments of the present disclosure. As shown in FIG. 3C, a processor of a computing system, at reference number 382, can obtain a set of content items depicting objects in sequences (e.g., “Frame Sequence”) with which to train the NeRF-based machine learning model. Based on depth maps of the objects, the processor, at reference number 384, can construct a fully connected graph associated with the set of content items. Each node of the fully connected graph represents a content item in the set of content items. The fully connected graph can be constructed based on a dissimilarity matrix of the set of content items. This dissimilarity matrix can indicate a degree of dissimilarity between the objects depicted in the set of content items. At reference number 386, the processor can evaluate the fully connected graph through a minimum spanning tree technique through which the fully connected graph is rearranged into multiple subtrees. Each path of the multiple subtrees corresponds to content items in an optimal training path with which to train to the NeRF-based machine learning model. At reference number 388, the processor can extract one or more optimal training paths from the multiple subtrees. The processor can use the one or more optimal training paths to train the NeRF-based machine learning model.

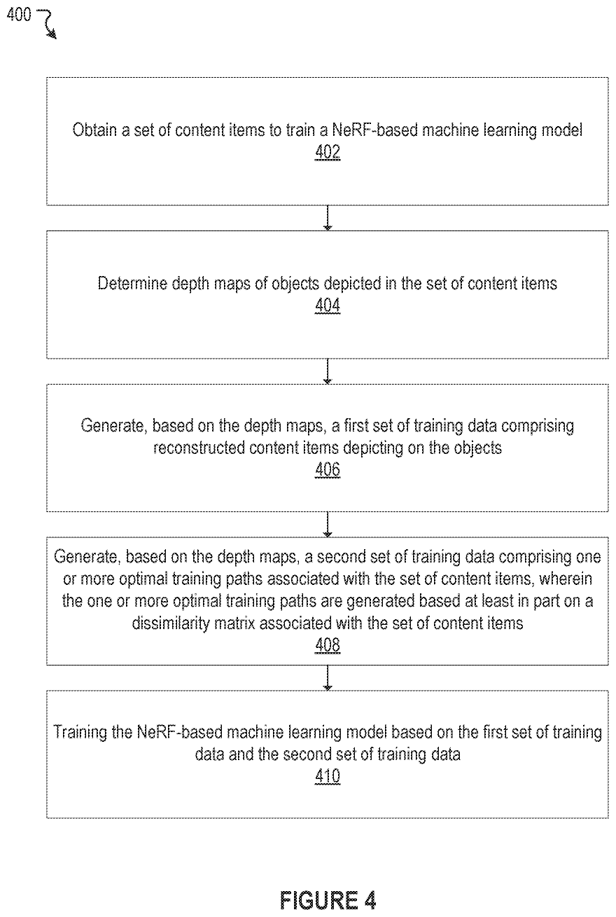

FIG. 4 illustrates a method 400 for training a NeRF-based machine learning model for object recognition, in accordance with various embodiments of the present disclosure. In this and other flowcharts, the method 400 illustrates by way of example a sequence of blocks. It should be understood the blocks may be reorganized for parallel execution, or reordered, as applicable. Moreover, some blocks that could have been included may have been removed to avoid providing too much information for the sake of clarity and some blocks that were included could be removed, but may have been included for the sake of illustrative clarity. The description from other figures may also be applicable to FIG. 4.

At block 402, a processor, such as a processor associated with the object recognition module 110 of FIG. 1, can obtain a set of content items to train a NeRF-based machine learning model. At block 404, the processor can determine depth maps of objects depicted in the set of content items. At block 406, the processor can generate, based on the depth maps, a first set of training data comprising reconstructed content items depicting only the objects. At block 408, the processor can generate, based on the depth maps, a second set of training data comprising one or more optimal training paths associated with the set of content items. At block 410, the processor can train the NeRF-based machine learning model based on the first set of training data and the second set of training data

The techniques described herein, for example, are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination.

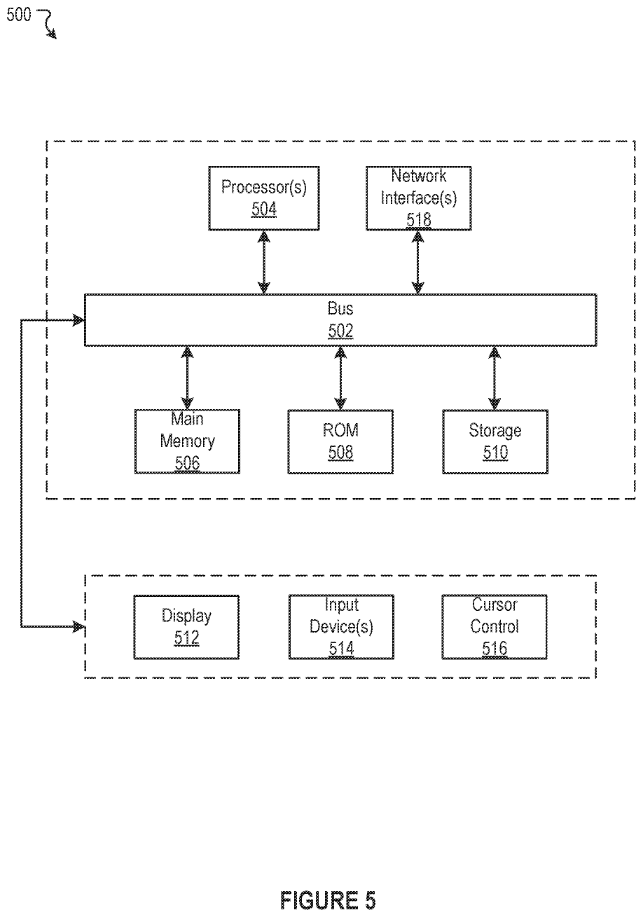

FIG. 5 is a block diagram that illustrates a computer system 500 upon which any of various embodiments described herein may be implemented. The computer system 500 includes a bus 502 or other communication mechanism for communicating information, one or more hardware processors 504 coupled with bus 502 for processing information. A description that a device performs a task is intended to mean that one or more of the hardware processor(s) 504 performs.

The computer system 500 also includes a main memory 506, such as a random access memory (RANI), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to output device(s) 512, such as a cathode ray tube (CRT) or LCD display (or touch screen), for displaying information to a computer user. Input device(s) 514, including alphanumeric and other keys, are coupled to bus 502 for communicating information and command selections to processor 504. Another type of user input device is cursor control 516. The computer system 500 also includes a communication interface 518 coupled to bus 502.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiment.

A component being implemented as another component may be construed as the component being operated in a same or similar manner as the another component, and/or comprising same or similar features, characteristics, and parameters as the another component.

1. A method of training a neural radiance field-based (NeRF-based) machine learning model for object recognition, the method comprising:
obtaining a set of content items to train the NeRF-based machine learning model;
determining depth maps of objects depicted in the set of content items;
generating, based on the depth maps, a first set of training data comprising reconstructed content items depicting only the objects;
generating, based on the depth maps, a second set of training data comprising one or more optimal training paths associated with the set of content items, wherein the one or more optimal training paths are generated based at least in part on a dissimilarity matrix associated with the set of content items; and
training the NeRF-based machine learning model based on the first set of training data and the second set of training data.

2. The method of claim 1, wherein determining the depth maps of the objects depicted in the set of content items comprises:
calculating, based on the set of content items, internal and external parameters of cameras from which the set of content items was captured;
determining, based on the internal and external parameters, coarse point clouds associated with the objects depicted in the set of content items;
determining, based on the coarse point clouds, meshes of the objects depicted in the set of content items; and
determining, based on the meshes of the objects, the depth maps of the objects depicted in the content items.

3. The method of claim 2, wherein the internal and external parameters of the cameras are determined using a Structure from Motion (SfM) technique and the meshes of the objects are determined using a Poisson reconstruction technique.

4. The method of claim 2, wherein the internal and external parameters of the cameras and the meshes of the objects are determined using a multiview depth fusion technique.

5. The method of claim 1, wherein generating the first set of training data comprising the reconstructed content items comprises:
determining, based on the depth maps, pixels in each content item of the set of content items to be filtered out;
filtering out the pixels in each content item of the set of content items; and
sampling remaining pixels in each content item of the set of content items to generate the reconstructed content items.

6. The method of claim 5, wherein determining the pixels in each content item of the set of content items to be filtered out comprises:
determining pixels in each content item of the set of content items that are outside a threshold depth range indicated by a corresponding depth map of each content item, wherein the threshold depth range indicates a depth range of at least one object depicted in each content item.

7. The method of claim 1, wherein generating the second set of training data comprising the one or more optimal training paths comprises:
determining depth maps matching metrics of the set of content items;
determining silhouette matching metrics of the set of content items;
generating, based on the depth maps matching metrics and the silhouette matching metrics, the dissimilarity matrix associated with the set of content items;
generating, based on the dissimilarity matrix, a connected graph associated with the set of content items; and
generating the one or more optimal training paths associated with the set of content items by applying a minimum spanning tree technique to the connected graph, wherein the minimum spanning tree technique rearranges the connected graph into multiple subtrees and each path of the multiple subtrees is an optimal training path.

8. The method of claim 7, wherein the depth map matching metrics of the set of content items are determined based on:
comparing depth maps of two content items of the set of content items, the two content items depicting an object;
computing a dissimilarity value of each depth point in the depth maps of the two content items; and
summing dissimilarity values of depth points in the depth maps of the two content items to generate a depth map matching metric for the two content items.

9. The method of claim 7, wherein the silhouette matching metrics of the set of content items are determined based on:
comparing depth maps of two content items of the set of content items, the two content items depicting an object;
comparing contour information associated with the object contained in the depth maps of the two content items; and
computing a silhouette matching metric for the two content items based on the comparison of the contour information.

10. The method of claim 7, wherein columns and rows of the dissimilarity matrix correspond to frame numbers associated with the set of the content items and values of the dissimilarity matrix indicate a degree of dissimilarity between any two content items of the set of content items as indicated by their respective frame numbers, and wherein the values of the dissimilarity matrix are determined based on respective depth map matching metric and the silhouette matching metric of any two content items of the set of content items.

11. A system comprising:
at least one processors; and
a memory storing instructions that, when executed by the at least one processor, cause the system to perform a method of training a neural radiance field-based (NeRF-based) machine learning model for object recognition, the method comprising:
obtaining a set of content items to train the NeRF-based machine learning model;
determining depth maps of objects depicted in the set of content items;
generating, based on the depth maps, a first set of training data comprising reconstructed content items depicting only the objects;
generating, based on the depth maps, a second set of training data comprising one or more optimal training paths associated with the set of content items, wherein the one or more optimal training paths are generated based at least in part on a dissimilarity matrix associated with the set of content items; and
training the NeRF-based machine learning model based on the first set of training data and the second set of training data.

12. The system of claim 11, wherein determining the depth maps of the objects depicted in the set of content items comprises:
calculating, based on the set of content items, internal and external parameters of cameras from which the set of content items was captured;
determining, based on the internal and external parameters, coarse point clouds associated with the objects depicted in the set of content items;
determining, based on the coarse point clouds, meshes of the objects depicted in the set of content items; and
determining, based on the meshes of the objects, the depth maps of the objects depicted in the content items.

13. The system of claim 11, wherein generating the first set of training data comprising the reconstructed content items comprises:
determining, based on the depth maps, pixels in each content item of the set of content items to be filtered out;
filtering out the pixels in each content item of the set of content items; and
sampling remaining pixels in each content item of the set of content items to generate the reconstructed content items.

14. The system of claim 13, wherein determining the pixels in each content item of the set of content items to be filtered out comprises:
determining pixels in each content item of the set of content items that are outside a threshold depth range indicated by a corresponding depth map of each content item, wherein the threshold depth range indicates a depth range of at least one object depicted in each content item.

15. The system of claim 11, wherein generating the second set of training data comprising the one or more optimal training paths comprises:
determining depth maps matching metrics of the set of content items;
determining silhouette matching metrics of the set of content items;
generating, based on the depth maps matching metrics and the silhouette matching metrics, the dissimilarity matrix associated with the set of content items;
generating, based on the dissimilarity matrix, a connected graph associated with the set of content items; and
generating the one or more optimal training paths associated with the set of content items by applying a minimum spanning tree technique to the connected graph, wherein the minimum spanning tree technique rearranges the connected graph into multiple subtrees and each path of the multiple subtrees is an optimal training path.

16. A non-transitory memory of a computing system storing instructions that, when executed by at least one processor of the computing system, causes the computing system to perform a method of training a neural radiance field-based (NeRF-based) machine learning model for object recognition, the method comprising:
obtaining a set of content items to train the NeRF-based machine learning model;
determining depth maps of objects depicted in the set of content items;
generating, based on the depth maps, a first set of training data comprising reconstructed content items depicting only the objects;
generating, based on the depth maps, a second set of training data comprising one or more optimal training paths associated with the set of content items, wherein the one or more optimal training paths are generated based at least in part on a dissimilarity matrix associated with the set of content items; and
training the NeRF-based machine learning model based on the first set of training data and the second set of training data.

17. The non-transitory memory of claim 16, wherein determining the depth maps of the objects depicted in the set of images comprises:
calculating, based on the set of content items, internal and external parameters of cameras from which the set of content items was captured;
determining, based on the internal and external parameters, coarse point clouds associated with the objects depicted in the set of content items;
determining, based on the coarse point clouds, meshes of the objects depicted in the set of content items; and
determining, based on the meshes of the objects, the depth maps of the objects depicted in the content items.

18. The non-transitory memory of claim 16, wherein generating the first set of training data comprising the reconstructed content items comprises:
determining, based on the depth maps, pixels in each content item of the set of content items to be filtered out;
filtering out the pixels in each content item of the set of content items; and
sampling remaining pixels in each content item of the set of content items to generate the reconstructed content items.

19. The non-transitory memory of claim 18, wherein determining the pixels in each content item of the set of content items to be filtered out comprises:
determining pixels in each content item of the set of content items that are outside a threshold depth range indicated by a corresponding depth map of each content item, wherein the threshold depth range indicates a depth range of at least one object depicted in each content item.

20. The non-transitory memory of claim 16, wherein generating the second set of training data comprising the one or more optimal training paths comprises:
determining depth maps matching metrics of the set of content items;
determining silhouette matching metrics of the set of content items;
generating, based on the depth maps matching metrics and the silhouette matching metrics, the dissimilarity matrix associated with the set of content items;
generating, based on the dissimilarity matrix, a connected graph associated with the set of content items; and
generating the one or more optimal training paths associated with the set of content items by applying a minimum spanning tree technique to the connected graph, wherein the minimum spanning tree technique rearranges the connected graph into multiple subtrees and each path of the multiple subtrees is an optimal training path.
